(19) United States
(12) Patent Application Publication
(10) Pub. No.: US 2025/0240269 A1
(43) Pub. Date: Jul. 24, 2025

(54) METHOD FOR CAN ID DISTRIBUTION

(71) Applicant: Analog Devices International Unlimited Company, Limerick (IE)

(72) Inventors: Rengui LUO, Beijing (CN); Yimiao ZHAO, Beijing (CN); Ling YANG, Beijing (CN); Euler CHEN, Beijing (CN)

(21) Appl. No.: 19/175,769

(22) Filed: Apr. 10, 2025

Related U.S. Application Data
(63) Continuation-in-part of application No. PCT/CN2022/132516, filed on Nov. 17, 2022.

(51) Int. Cl. H04L 61/5038; H04L 12/40; H04L 101/627

(52) U.S. Cl. CPC H04L 61/5038; H04L 12/40143; H04L 2012/40215; H04L 2101/627

(57) ABSTRACT

Example implementations include methods, apparatuses, and computer-readable medium of network identification (ID) distribution by devices in a network, which may be host devices or other devices. An example method includes sending a host ID on a communication bus, such as a controller area network (CAN) bus, receiving a first device ID from a first node in a plurality of nodes on the CAN bus, distributing a first unique network ID value to the first node in the plurality of nodes on the CAN bus, confirming that the first node in the plurality of nodes has received the first unique network ID value, and repeating the method until each node in the plurality of nodes has been assigned the respective unique network ID value.

### CROSS-REFERENCE TO RELATED APPLICATIONS

This application is a continuation-in-part of and claims priority to International Application number PCT/CN2022/132516, filed on Nov. 17, 2022, which is incorporated by reference herein in its entirety.

### BACKGROUND

### Technical Field

The described aspects relate to bus networking architectures, and specifically to controller area network (CAN) identification (ID) distribution.

### INTRODUCTION

Networking architectures have grown increasingly complex and have been designed for use in a wide variety of communications environments. Demand continues to rise among the subscriber base of end users, however, for network access across diverse network environments. In particular, configuring suitable network architecture for vehicular environments (e.g., automobiles, electric vehicles, airplanes, trains, boats, etc.) presents unique difficulties. Vehicles can be mobile across a large geographical area, can travel at variable speeds, can have internal networks related to the vehicle itself, and can include more than one end user at a time. Providing the ability to conduct transactions in vehicular network environments in an optimized manner and providing a secure and flexible communication framework for various agents conducting the transactions present significant challenges to system designers, automobile manufacturers and the like. Networking architectures are also used in energy storage systems where a number of batteries are coupled together and the voltage and current of each battery cell are managed by one or more processors.

Electric vehicles have unique demands in that the battery power for the vehicle are monitored and determined regularly, as problems with battery power availability may result stranded vehicles.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of network identification (ID) distribution by a host device in a network, comprising sending a host ID on a communication bus. The method further includes receiving a device ID from a first node in a plurality of nodes on the communication bus. Additionally, the method further includes distributing a first unique network ID value to the first node in the plurality of nodes on the communication bus. Additionally, the method further includes repeating the sending of the host ID on the communication bus, the receiving of a respective device ID from each remaining node in the plurality of nodes, and the distributing of a unique network ID value to each remaining node in the plurality of nodes until each node in the plurality of nodes has been assigned a respective unique network ID value.

Another example aspect includes an apparatus for network identification (ID) distribution by a host device in a network, comprising a memory and a processor communicatively coupled with the memory. The processor is configured to send a host ID on a communication bus. The processor is further configured to receive a device ID from a first node in a plurality of nodes on the communication bus. Additionally, the processor further configured to distribute a first unique network ID value to the first node in the plurality of nodes on the communication bus. Additionally, the processor further configured to repeat the sending of the host ID on the communication bus, the receiving of a respective device ID from each remaining node in the plurality of nodes, and the distributing of a unique network ID value to each remaining node in the plurality of nodes until each node in the plurality of nodes has been assigned a respective unique network ID value.

Another example aspect includes an apparatus for network identification (ID) distribution by a host device in a network, comprising means for sending a host ID on a communication bus. The apparatus further includes means for receiving a device ID from a first node in a plurality of nodes on the communication bus. Additionally, the apparatus further includes means for distributing a first unique network ID value to the first node in the plurality of nodes on the communication bus. Additionally, the apparatus further includes means for repeating the sending of the host ID on the communication bus, the receiving of a respective device ID from each remaining node in the plurality of nodes, and the distributing of a unique network ID value to each remaining node in the plurality of nodes until each node in the plurality of nodes has been assigned a respective unique network ID value.

Another example aspect includes a computer-readable medium having instructions stored thereon of network identification (ID) distribution by a host device in a network, wherein the instructions are executable by a processor to send a host ID on a communication bus. The instructions are further executable to receive a device ID from a first node in a plurality of nodes on the communication bus. Additionally, the instructions are further executable to distribute a first unique network ID value to the first node in the plurality of nodes on the communication bus. Additionally, the instructions are further executable to repeat the sending of the host ID on the communication bus, the receiving of a respective device ID from each remaining node in the plurality of nodes, and the distributing of a unique network ID value to each remaining node in the plurality of nodes until each node in the plurality of nodes has been assigned a respective unique network ID value.

An example aspect includes a method of network identification (ID) distribution by a client device of a plurality of client devices in a network, comprising receiving a first message including a host ID and a generic ID value on a communication bus, wherein the generic ID value is associated with the client device. The method further includes sending a device ID on the communication bus. Additionally, the method further includes receiving a unique network ID value on the communication bus.

Another example aspect includes an apparatus for network identification (ID) distribution by a client device of a plurality of client devices in a network, comprising a state machine. The state machine may also be embodied with a processor and a memory if desired. The state machine is configured to receive a first message including a host ID and a generic ID value on a communication bus, wherein the generic ID value is associated with the client device. The state machine is further configured to send a device ID on the communication bus. Additionally, the state machine may be further configured to receive a unique network ID value on the communication bus.

Another example aspect includes an apparatus for network identification (ID) distribution by a client device of a plurality of client devices in a network, comprising means for receiving a first message including a host ID and a generic ID value on a communication bus, wherein the generic ID value is associated with the client device. The apparatus further includes means for sending a device ID on the communication bus. Additionally, the apparatus further includes means for receiving a unique network ID value on the communication bus.

Another example aspect includes a computer-readable medium having instructions stored thereon of network identification (ID) distribution by a client device of a plurality of client devices in a network, wherein the instructions are executable by a processor to receive a first message including a host ID and a generic ID value on a communication bus, wherein the generic ID value is associated with the client device. The instructions are further executable to send a device ID on the communication bus. Additionally, the instructions are further executable to receive a unique network ID value on the communication bus.

Another example aspect includes a method of controller area network (CAN) identification (ID) distribution by a host device in a network in accordance with an aspect of the present disclosure comprises sending a host ID on a CAN bus, receiving a first device ID from a first node in a plurality of nodes on the CAN bus, distributing a first unique network ID value to the first node in the plurality of nodes on the CAN bus, confirming that the first node in the plurality of nodes has received the first unique network ID value, and repeating the sending of the host ID on the CAN bus, the receiving of a respective device ID from each remaining node in the plurality of nodes, the distributing of a respective unique network ID value to each remaining node in the plurality of nodes, and the confirming that each remaining node has received the respective unique network ID value until each node in the plurality of nodes has been assigned the respective unique network ID value.

Such a method further optionally comprises the device ID being received in a frame ID field, the first node being a highest priority node on the CAN bus, receiving a device ID from each remaining node in the plurality of nodes occurs in order of priority of each remaining node in the plurality of nodes, and receiving a predetermined response from the first node and each remaining node in the plurality of nodes.

Such a method in distributing the first unique network ID value to the first node in the plurality of nodes on the CAN bus may optionally further comprise transmitting a broadcast ID assign value assigned to the first node in the plurality of nodes on the CAN bus, and transmitting the first unique network ID value in a data field associated with the broadcast ID assign value assigned to the first node in the plurality of nodes on the CAN bus, and in confirming that the first node in the plurality of nodes has received the first unique network ID value, may further comprise receiving a response message from the first node in the plurality of nodes, transmitting an individual read frame ID having the first unique network ID value on the CAN bus, and associating the first unique network ID value with the first node.

Such a method may further optionally comprise the device ID is received in a data field, sending a message addressed to a generic device ID, wherein the generic device ID is common to each node in the plurality of nodes, and the first node being a first node to respond to the sending of the host ID on the CAN bus.

Such a method, in distributing a first unique network ID value to the first node in the plurality of nodes on the CAN bus, may further comprise transmitting an extend frame having the first device ID in a frame ID field and the first unique network ID in a data field, and in confirming that the first node in the plurality of nodes has received the first unique network ID value may further comprise transmitting a data request message to the first node, the data request message having the first unique network ID value in the frame ID field, receiving a response message having the host ID in the frame ID field and predetermined data in the data field, and recording the first unique network ID in association with the first node in an address mapping list.

Another example aspect includes an apparatus for controller area network (CAN) identification (ID) distribution by a host device in a network in accordance with an aspect of the present disclosure may comprise a memory, and a processor communicatively coupled with the memory and configured to send a host ID on a CAN bus, receive a first device ID from a first node in a plurality of nodes on the CAN bus, distribute a first unique network ID value to the first node in the plurality of nodes on the CAN bus, confirm that the first node in the plurality of nodes has received the first unique network ID value, and repeat the sending of the host ID on the CAN bus, the receiving of a respective device ID from each remaining node in the plurality of nodes, the distributing of a respective unique network ID value to each remaining node in the plurality of nodes, and the confirming that each remaining node has received the respective unique network ID value until each node in the plurality of nodes has been assigned the respective unique network ID value.

Such an apparatus may further optionally include the device ID being received in a frame ID field, the first node being a highest priority node on the CAN bus, and the device ID received from each remaining node in the plurality of nodes occurs in order of priority of each remaining node in the plurality of nodes.

Such an apparatus may further optionally comprise, when confirming that the first node in the plurality of nodes has received the first unique network ID value and confirming that each remaining node in the plurality of nodes has received the respective unique device ID value, the processor is further configured to receive a predetermined response from the first node and each remaining node in the plurality of nodes.

Such an apparatus, in when the first unique network ID value is distributed to the first node in the plurality of nodes on the CAN bus, the processor may be further configured to transmit a broadcast ID assign value assigned to the first node in the plurality of nodes on the CAN bus and transmit the first unique network ID value in a data field associated with the broadcast ID assign value assigned to the first node in the plurality of nodes on the CAN bus, and when confirming that the first node in the plurality of nodes has received the first unique network ID value, the processor may be further configured to receive a response message from the first node in the plurality of nodes, transmit an individual read frame ID having the first unique network ID value on the CAN bus, and associate the first unique network ID value with the first node.

Such an apparatus may further optionally comprise the device ID being received in a data field, and the processor, when sending the host ID, being further configured to send a message addressed to a generic device ID, wherein the generic device ID is common to each node in the plurality of nodes.

Such an apparatus may further optionally comprise the first node being a first node to respond to the sending of the host ID on the CAN bus.

Such an apparatus, in distributing a first unique network ID value to the first node in the plurality of nodes on the CAN bus, the processor may be further configured to transmit an extend frame having the first device ID in a frame ID field and the first unique network ID in a data field, and when confirming that the first node in the plurality of nodes has received the first unique network ID value the processor may be further configured to transmit a data request message to the first node, the data request message having the first unique network ID value in the frame ID field, receive a response message having the host ID in the frame ID field and predetermined data in the data field, and record the first unique network ID in association with the first node in an address mapping list.

Another example aspect includes a method of obtaining a controller area network (CAN) identification (ID) by a node of a plurality of nodes in a network in accordance with an aspect of the present disclosure may comprise receiving a first message including a host ID value on a CAN bus, sending a second message addressed to the host ID value and including a device ID on the CAN bus, and receiving a unique network ID value on the CAN bus.

Such a method may further optionally include the device ID being sent in a frame ID field, the node being a highest priority node on the CAN bus, and the device ID being sent in a data field.

Such a method may further optionally comprise receiving an extend frame with the unique network ID value in the data field, and transmitting the unique network ID value in the data field on the CAN bus.

Such a method, when receiving the host ID, may further optionally comprise receiving a message addressed to a generic device ID, wherein the generic device ID is common to each client device in the plurality of nodes.

Another example aspect includes an apparatus for controller area network (CAN) identification (ID) distribution to a plurality of nodes in a network in accordance with an aspect of the present disclosure may comprise a state machine configured to receive a first message including a host ID value on a CAN bus, send a device ID on the CAN bus from a first node in the plurality of nodes, and receive a unique network ID value on the CAN bus.

Such an apparatus may further optionally comprise the state machine being further configured to send the device ID in a frame ID field.

Such an apparatus may further optionally comprise the first node being a highest priority node on the CAN bus.

Such an apparatus may further optionally comprise the state machine being further configured to receive the device ID in a data field.

Such an apparatus may further optionally comprise the state machine being further configured to receive an extend frame with the unique network ID value in the data field and transmit the unique network ID value in the data field on the CAN bus.

Such an apparatus may further optionally comprise the state machine being further configured to receive a message addressed to a generic device ID, wherein the generic device ID is common to each node in the plurality of nodes.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 illustrates a bus architecture in accordance with an aspect of the present disclosure;

FIG. 2 illustrates a device coupled to the bus architecture in accordance with an aspect of the present disclosure;

FIG. 3 is a communications flow diagram in accordance with an aspect of the present disclosure;

FIG. 4 is a block diagram of an example of a computer device having components configured to perform a method of network identification (ID) distribution by a host device in a network;

FIG. 5 is a flowchart of an example of a method of network identification (ID) distribution by a host device in a network;

FIG. 6 is a flowchart of additional aspects of the method of FIG. 5;

FIG. 7 is a flowchart of additional aspects of the method of FIG. 5;

FIG. 8 is a flowchart of additional aspects of the method of FIG. 5;

FIG. 9 is a flowchart of additional aspects of the method of FIG. 5;

FIG. 10 is a block diagram of an example of a computer device having components configured to perform a method of network identification (ID) distribution by a client device of a plurality of client devices in a network;

FIG. 11 is a flowchart of an example of a method of network identification (ID) distribution by a client device of a plurality of client devices in a network;

FIG. 12 is a flowchart of additional aspects of the method of FIG. 11;

FIG. 13 is a flowchart of additional aspects of the method of FIG. 11;

FIG. 14 is a communications flow diagram in accordance with an aspect of the present disclosure;

FIG. 15 is a flowchart of an example of a method of network identification (ID) distribution by a host device in a network;

FIG. 16 is a flowchart of additional aspects of the method of FIG. 15;

FIG. 17 is a flowchart of additional aspects of the method of FIG. 15;

FIG. 18 is a flowchart of additional aspects of the method of FIG. 15;

FIG. 19 is a flowchart of additional aspects of the method of FIG. 15;

FIG. 20 is a flowchart of additional aspects of the method of FIG. 15;

FIG. 21 is a flowchart of additional aspects of the method of FIG. 15;

FIG. 22 is a flowchart of additional aspects of the method of FIG. 15;

FIG. 23 is a flowchart of additional aspects of the method of FIG. 15;

FIG. 24 is a flowchart of additional aspects of the method of FIG. 15;

FIG. 25 is a flowchart of an example of a method of network identification (ID) distribution by a node in a plurality of nodes in a network;

FIG. 26 is a flowchart of additional aspects of the method of FIG. 24;

FIG. 27 is a flowchart of additional aspects of the method of FIG. 24;

FIG. 28 is a flowchart of additional aspects of the method of FIG. 24;

FIG. 29 is a flowchart of additional aspects of the method of FIG. 24; and

FIG. 30 is a flowchart of additional aspects of the method of FIG. 24.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Aspects of the present disclosure describe methods and apparatuses for distribution of identification (ID) values or numbers to nodes or devices in a communications network. In some aspects, the communications network is a controller area network (CAN). In some aspects, the data field of a CAN message (also referred to as a “frame”) is used to distribute the ID values. In some aspects, the broadcast read frame is used to distribute the ID values. In such aspects, different configurations of networks, and different devices on the network, may respond appropriately to one or both of the distribution techniques. Further, depending on the network, one technique for distribution may be more efficient or faster than another.

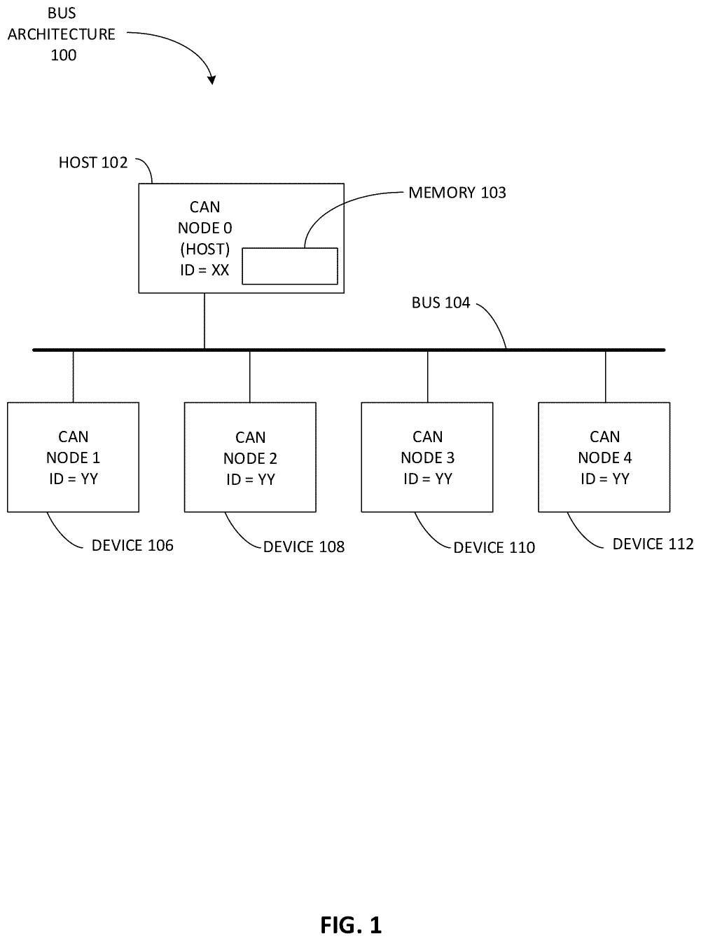

FIG. 1 illustrates a bus architecture in accordance with an aspect of the present disclosure.

An electric vehicle, or other network, may include a bus architecture 100, which may comprise a host 102 which has memory 103, a bus 104 (or network), and one or more devices 106-112. A larger or smaller number of devices (also known as “nodes”) 106-112 may be included in bus architecture 100 without departing from the scope of the present disclosure. Host 102 may be described as an apparatus, device, processor, or other network machine as part of the present disclosure.

In an aspect of the present disclosure, bus architecture 100 may be a Controller Area Network (CAN). CAN networks are used in battery management systems, such as in automotive electric vehicles or in energy storage systems. Host 102 may be a processor or microcontroller, which communicates with various other devices through bus 104. In CAN networks, device 106, device 108, device 110, and device 112 may be battery packs. Device 106, device 108, device 110, and device 112 may be described as an apparatus, device, sensor, or other network machine as part of the present disclosure.

To use bus 104 as a common communications pathway, each device 106-112 connected to the bus 104 may have a unique identification (ID) number.

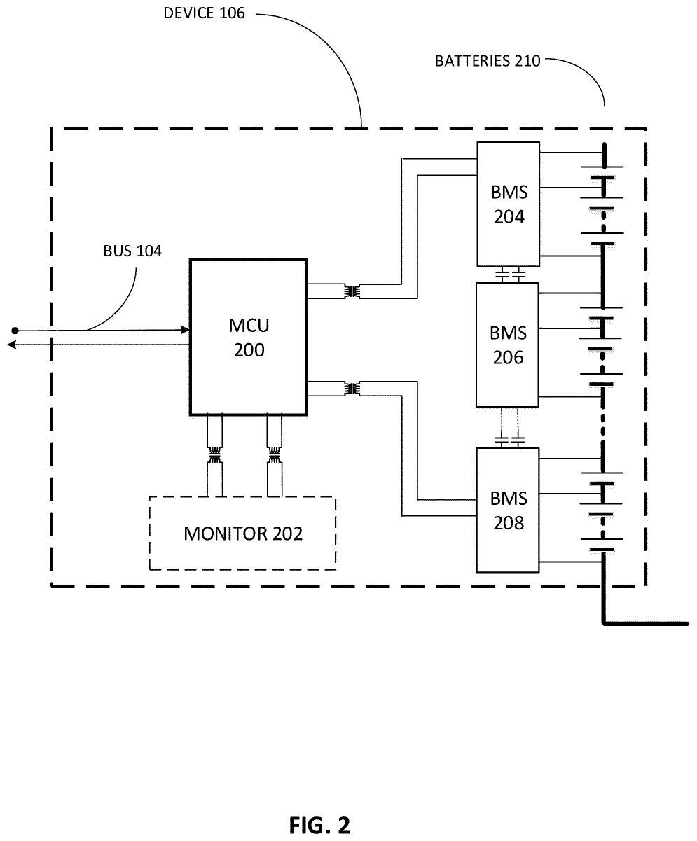

FIG. 2 illustrates a device coupled to the bus architecture in accordance with an aspect of the present disclosure.

FIG. 2 illustrates a device 106 coupled to bus 104. Although referred to as device 106, the device shown in FIG. 2 could be any device coupled to the bus 104 without departing from the scope of the present disclosure. Within device 106, a microcontroller unit (MCU) 200 is coupled to the bus 104, and an optional battery pack monitor 202 is coupled to MCU 200. Also coupled to MCU 200 are one or more battery cell monitors, which may include an analog front end (AFE) and/or cell monitor unit (CMU) 204, AFE/CMU 206, AFE/CMU 208, and batteries 210 are coupled in series to produce a voltage from device 106. Battery cell monitors 204, 206, and/or 208 may also be referred to as battery management systems (BMS) herein.

In an aspect of the present disclosure, host 102 may assign an ID number (or value) to each device 106 (e.g., devices 106-112) coupled to bus 104. When there are multiple devices coupled to bus 104, host 102 can control the assignment of ID number values to each device 106-112. In such an aspect, MCU 200, battery pack monitor 202, or other portions of device 106 may not contain non-volatile memory (NVM) storing the unique ID number for device 106, which may reduce costs and complexity for each device 106 coupled to the bus 104. Further, MCU 200 may be implemented as a state machine, e.g., an integrated circuit, rather than a processor, as host 102 may control the communications on bus 104. Processing power, non-volatile memory (NVM), and/or other circuitry in MCU 200 may not be necessary, or may be reduced in nature, in accordance with an aspect of the present disclosure. Since host 102 is performing assignment of the network ID numbers, devices 106-112 can be reduced in complexity and may have reduced costs.

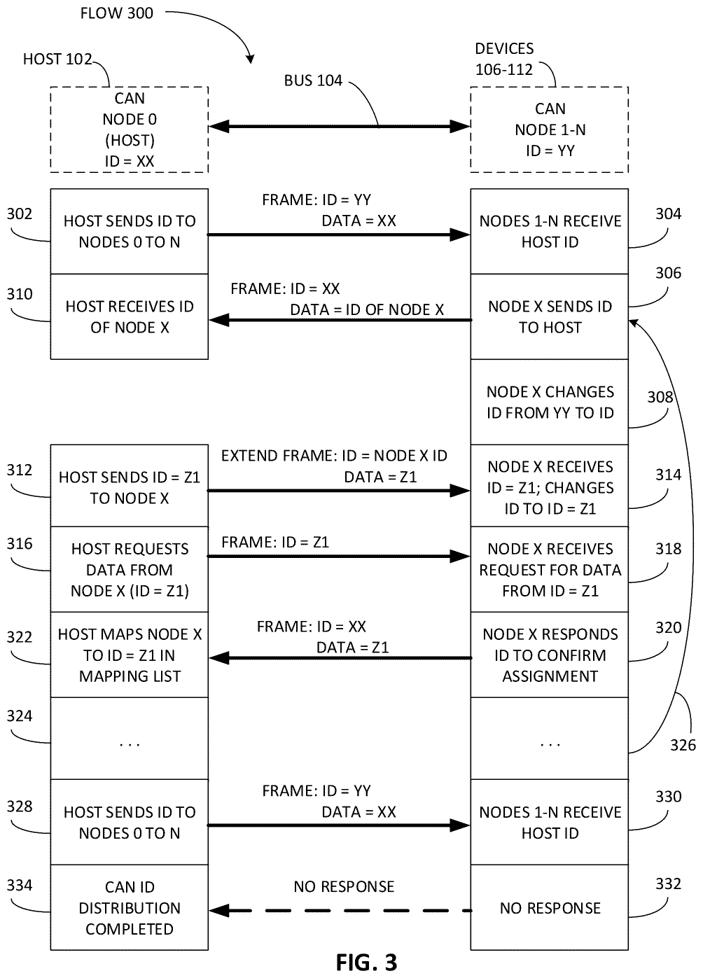

FIG. 3 is a communications flow diagram in accordance with an aspect of the present disclosure.

Flow 300 illustrates a communications flow between host 102 and devices 106-112 on bus 104. Each connection, or “node” to bus 104 has a logical number assigned to that connection. In an aspect of the present disclosure, bus 104 is a CAN bus, and host 102 is assigned to logical Node 0 on bus 104.

Host 102 may be a processor or other microcontroller that initiates and receives electrical signals (“messages”) over bus 104 to monitor the status of each of the devices 106-112 on the bus 104. However, to manage the electrical signals on bus 104, each device 106-112 on bus 104 may also be assigned a logical number as a node on bus 104. These nodes or logical number assignments may be referred to as node 1, node 2, etc., and may be referred to as “nodes 1-n” to denote “n” number of nodes on the bus 104. These nodes are given specific identifiers in the present disclosure.

Host 102 may be assigned to CAN node 0 and has a bus ID (also referred to as a CAN ID herein) of a specific value. For example, and not by way of limitation, host 102 may be assigned a bus ID of “XX”, although any device ID can be used without departing from the scope of the present disclosure.

Each of devices 106-112 may have a common or generic network ID as a default prior to bus 104 initialization. As such, the generic network ID for each device 106-112 may be referred to as “YY” herein. The network ID for each device 106-112 for a particular bus 104 may be assigned by host 102 as described herein.

During communication on the bus 104, an identifier, e.g., the device ID of the initiator (sender) of the recipient of the message may be referred to as the “data” of the message, and the intended recipient may be referred to as the “frame” of the message being sent.

In message 302, host 102 sends the host device ID (XX), which is the CAN bus ID or CAN ID, to the devices 106-112 on bus 104. The data (XX) is sent to a frame ID of “YY” which each device 106-112 on bus 104 has as a generic frame ID. In some aspects, the CAN bus ID for host 102 will not be changed during operation of the bus architecture 100.

Although each device 106-112 will receive the host ID in operation 304, since the frame ID (the generic target or addressed bus node) is the same for each device 106-112, only one device 106-112 will be able to control the bus 104 to return a message on bus 104. Once one of the devices 106-112 acquires control over bus 104, e.g., the first device 106-112 to respond to host 102, the other devices on bus 104 will not be allowed to access the bus 104, e.g., those devices will have bus 104 transmission communications “disabled”. The disabled devices on bus 104 can still receive messages from host 102 or other devices 106-112 on bus 104, but the disabled devices are in “listen” mode, which means the disabled devices 106-112 can still respond to a message with frame=YY (as a device ID).

Whichever device 106-112 acquires control over bus 104, which will be referred to as “node X”, in message 306 node X will send a device ID to host 102 on bus 104. The device ID for the device 106-112 (node X) can be any unique identifier for that device. For example, node X sends a message having a Frame ID of “XX,” which corresponds to the host device ID, and having a data field including the value of the device ID of node X.

In an aspect of the present disclosure, the device ID for a given device 106-112 may be a serial number of the device 106-112, e.g., a printed circuit board ID. Such a device ID may be sent in a CAN bus message schema in a CAN frame as an 11-bit identifier. The 11-bit identifier can be set by default or by host 102 assignment.

In an aspect of the present disclosure, the device ID for a given device 106-112 may be an extended ID (EID) of the device. The EID, in a CAN bus standard message schema, is the ID in the CAN extended message frame as a 29-bit identifier, which includes the 11-bit base identifier described above, and 18-bit extended identifier. The 29-bit identifier can be generated from the unique ID of an integrated circuit or other part on device 106-112.

In operation 308, the device 106-112 that acquired bus 104 (at node X) changes its ID from the generic, initial “YY” identifier to the unique device ID communicated to the host 102 in message 306. In an aspect of the present disclosure, node X may change its ID to the device ID or the EID of that device, as described above, although any unique device ID value, such as a unique part number, may be used without departing from the scope of the present disclosure.

In operation 310, host 102 receives the device ID from node X, which may be the device ID or EID of whichever device 106-112 is at node X over bus 104. Host 102 then configures (assigns) a network ID for node X, and in operation 312, sends this network ID to node X. Operation 312 may use an extended message frame on bus 104 to send the network ID back to node X. For example, the extended message frame may have an Extend Frame field having a value of the device ID or EID of node X, and a data field having a value of Z1. For ease of understanding, network IDs may be referred to as “Zn” where n is the number of the node on bus 104. In operation 312, network ID would be “Z1” as this is the first network ID assigned by host 102.

In operation 314, the device 106-112 at node X receives the network ID (Z1) from host 102 on bus 104. Upon receipt, operation 314 changes the ID of node X (e.g., the device ID or EID) to the network ID Z1.

Operation 316 starts the confirmation process for host 102 and node X. In operation 316, host 102 requests data from device 106-112 at node x by sending a frame ID of Z1 to bus 104. The device 106-112 that is at node X has that bus 104 address, so only that device will respond to host 102. If the operations 308-316 have gone correctly for node X, node X will receive the data request in operation 318 and will respond in operation 320 to host 102, which confirms that the device 106-112 at node X has completed the network ID assignment.

If one or more of the operations 308-314 have not been performed correctly, when host 102 attempts to confirm assignment of the network ID in operation 316, host 102 will not receive a response from node X in operation 320. This may result in a resetting of the device 106-112 at node X to the “YY” bus ID and that particular device may be assigned a new network ID later in the process.

If host 102 receives the confirmation message sent in operation 320, host 102 maps node X (and the device 106-112 at node X) to the ID sent to node X in operation 322. This mapping informs host 102 of the device 106-112 that is present at the bus 104 node assigned by host 102. The mapped network ID may be stored or recorded in memory 103 for use by host 102 on bus 104.

Operations 324 and 326 show a repetition of steps 302-320 for the additional devices 106-112 that are coupled to bus 104. Each device 106-112 will sequentially acquire the bus, send their device IDs to host 102, and go through the steps to have a network ID assigned by host 102.

Operation 328 illustrates host 102 sending the “generic” YY network ID message on bus 104, and each of the devices 106-112 (that have all been assigned nodes and network IDs) receiving this message at operation 330. Since all of the devices 106-112 have been assigned new network IDs by host 102, none of the devices 106-112 will respond. Either no response will occur in operation 332, or a timeout for response on bus 104 will occur, and operation 334 will indicate to host 102 that all network IDs have been distributed to the devices 106-112 on bus 104.

As shown in FIG. 3, host 102 distributes network IDs to device 106, device 108, device 110, and device 112, and stores the distributed network IDs for bus 104 communication purposes.

In other words, to summarize, in the communications flow 300, CAN Node 0, e.g., the host including a processor, which has a different CAN ID as compared to other CAN Nodes in default by the hardware setting, and its CAN ID (XX) will not be changed during the whole operation. The host will be in charge of the CAN Nodes ID management and distribution In the CAN network.

Further, CAN Node 1 to n are general CAN Nodes with the same CAN ID (YY) in default by the hardware setting. Their CAN ID will be assigned by the CAN Node 0 (host) during the CAN network initial stage.

Also, each of CAN Node 1 to n will have a unique identification code in hardware, such as a unique ID (UID), which may be from unique identification of the IC on the respective board. In some cases, each of CAN Node 1 to n will generate an extended CAN Node ID (29-bit) from the unique identification code, which can be taken as the unique ID of the CAN Node.

At the CAN network initial stage, CAN Node 0 (Host) knows the default ID of CAN Node 1 to n, in this example ID=YY, but the CAN Nodes 1 to n do not know the ID of host.

Then, the host distributes CAN IDs to CAN Nodes 1 to n as Z1 to Zn.

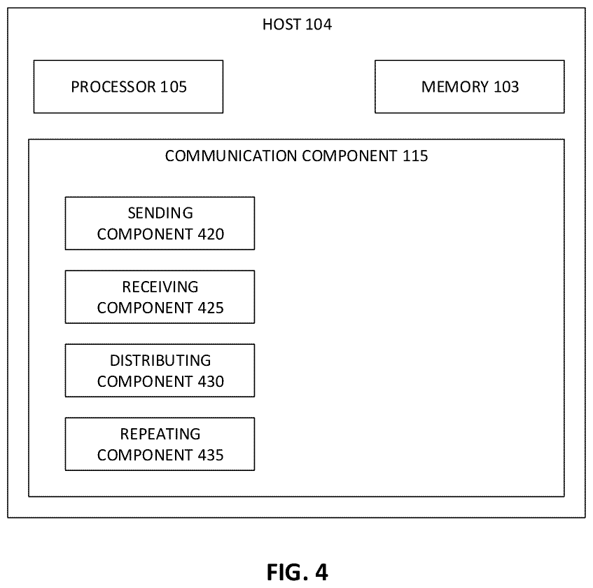

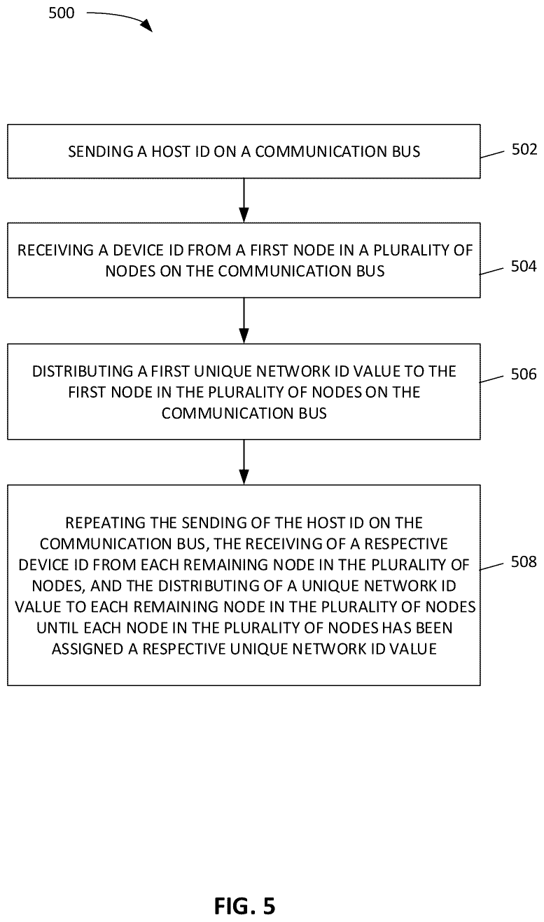

FIG. 4 is a block diagram of an example of a computer device having components configured to perform a method of network identification (ID) distribution by a host device in a network, and FIG. 5 is a flowchart of an example of a method of a method of network identification (ID) distribution by a host device in a network.

Referring to FIG. 4 and FIG. 5, in operation, host 102 device in a bus architecture 100 (or other network) may perform a method 500 of network identification (ID) distribution such as via execution of by host 102, processor 105 or memory 103.

At block 502, the method 500 includes sending a host ID on a communication bus. For example, in an aspect, host 102, memory 103, processor 105, communication component 115, and/or sending component 420 may be configured to or may comprise means for sending a host ID on a communication bus.

For example, the sending at block 502 may include sending electrical signals from host 102 to devices 106-112 on bus 104 to begin assignment of network IDs.

Further, for example, the sending at block 502 may be performed by host 102 to inform devices 106-112 of the host 102 network ID.

At block 504, the method 500 includes receiving a device ID from a first node in a plurality of nodes on the communication bus. For example, in an aspect, host 102, memory 103, processor 105, communication component 115, and/or receiving component 425 may be configured to or may comprise means for receiving a device ID from a first node in a plurality of nodes on the communication bus.

For example, the receiving at block 504 may include receiving electrical signals from one of devices 106-112 on bus 104 at host 102.

Further, for example, the receiving at block 504 may be performed to let host 102 know that one of devices 106-112 is able to communicate on bus 104.

At block 506, the method 500 includes distributing a first unique network ID value to the first node in the plurality of nodes on the communication bus. For example, in an aspect, host 102, memory 103, processor 105, communication component 115, and/or distributing component 430 may be configured to or may comprise means for distributing a first unique network ID value to the first node in the plurality of nodes on the communication bus.

For example, the distributing at block 506 may include determining a unique network ID at host 102 and assigning this to the responding node on bus 104.

Further, for example, the distributing at block 506 may be performed to begin communication with one of devices 106-112.

At block 508, the method 500 includes repeating the sending of the host ID on the communication bus, the receiving of a respective device ID from each remaining node in the plurality of nodes, and the distributing of a unique network ID value to each remaining node in the plurality of nodes until each node in the plurality of nodes has been assigned a respective unique network ID value. For example, in an aspect, host 102, memory 103, processor 105, communication component 115, and/or repeating component 435 may be configured to or may comprise means for repeating the sending of the host ID on the communication bus, the receiving of a respective device ID from each remaining node in the plurality of nodes, and the distributing of a unique network ID value to each remaining node in the plurality of nodes until each node in the plurality of nodes has been assigned a respective unique network ID value.

For example, the repeating at block 508 may include assigning unique network IDs to each of devices 106-112 on bus 104.

In an alternative or additional aspect, the network is a controller area network (CAN).

In an alternative or additional aspect, the device ID is based on an extended ID (EID).

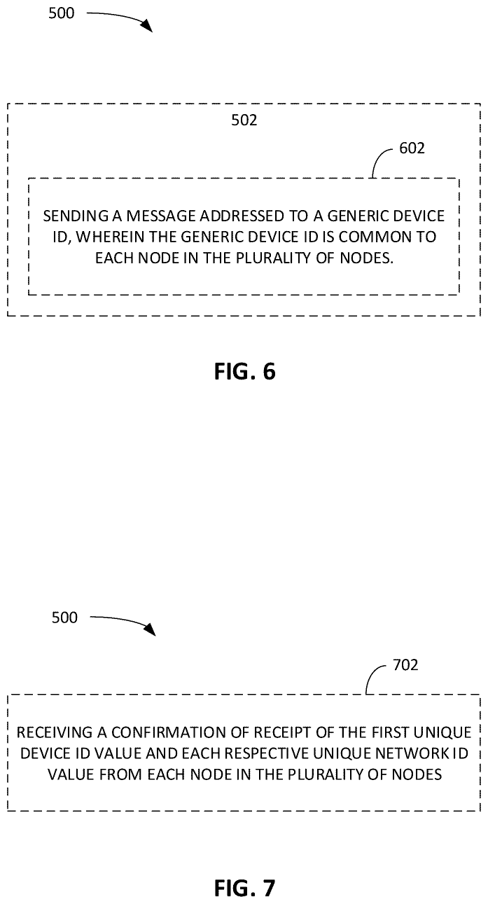

FIG. 6 is a flowchart of additional aspects of the method of FIG. 5.

Referring to FIG. 6, in an alternative or additional aspect, at block 602, the sending at block 502 of the host ID comprises sending a message addressed to a generic device ID, wherein the generic device ID is common to each node in the plurality of nodes.

FIG. 7 is a flowchart of additional aspects of the method of FIG. 5.

Referring to FIG. 7, in an alternative or additional aspect, at block 702, the method 500 may further include receiving a confirmation of receipt of the first unique device ID value and each respective unique network ID value from each node in the plurality of nodes.

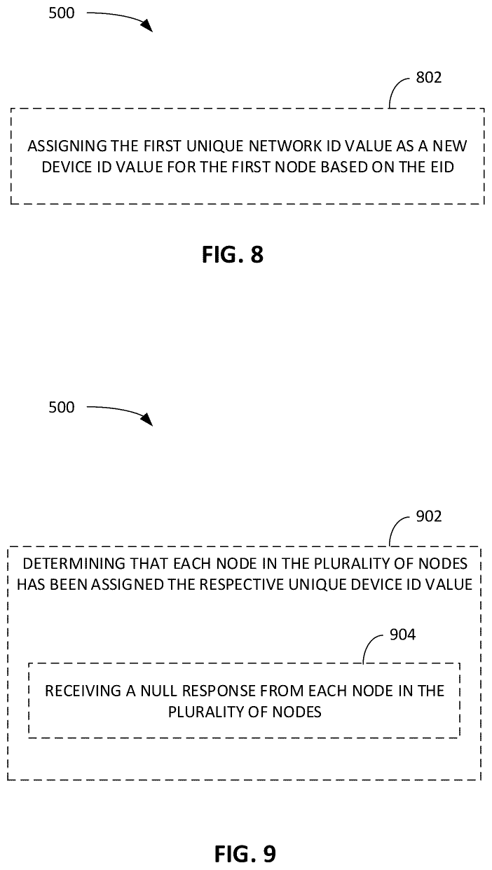

FIG. 8 is a flowchart of additional aspects of the method of FIG. 5.

Referring to FIG. 8, in an alternative or additional aspect, at block 802, the method 500 may further include assigning the first unique network ID value as a new device ID value for the first node based on the EID.

FIG. 9 is a flowchart of additional aspects of the method of FIG. 5.

Referring to FIG. 9, in an alternative or additional aspect, at block 902, the method 500 may further include determining that each node in the plurality of nodes has been assigned the respective unique device ID value.

In this optional aspect, at block 904, the determining at block 902 that each node in the plurality of nodes has been assigned the respective unique device ID value comprises receiving a null response from each node in the plurality of nodes.

For example, either no response will be received, or a determined amount of time will transpire before a response is received at host 102, indicating that no other devices 106-112 have the original or generic device ID.

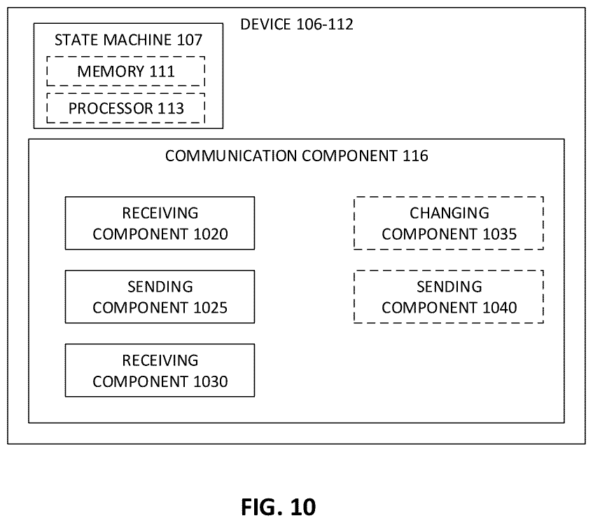

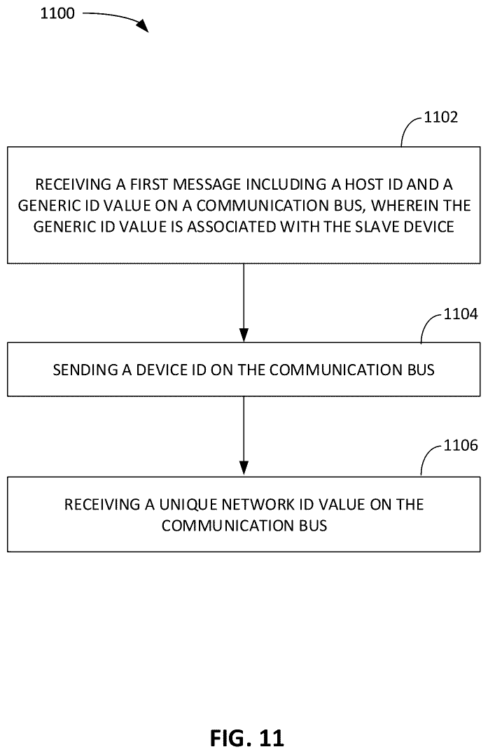

FIG. 10 is a block diagram of an example of a computer device having components configured to perform a method of network identification (ID) distribution by a client device of a plurality of client devices in a network, and FIG. 11 is a flowchart of an example of a method of a method of network identification (ID) distribution by a client device of a plurality of client devices in a network. Client devices may also be referred to as “nodes” on bus 104 herein.

Referring to FIG. 10 and FIG. 11, in operation, device 106-112, such as a client device in a network, may perform a method 1100 of network identification (ID) distribution such as via execution by device 106-112.

At block 1102, the method 1100 includes receiving a first message including a host ID and a generic ID value on a communication bus, wherein the generic ID value is associated with the client device. For example, in an aspect, device 106-112, state machine 107, (which may be embodied as an optional memory 111 and processor 113), communication component 116, and/or receiving component 1020 may be configured to or may comprise means for receiving a first message including a host ID and a generic ID value on a communication bus, wherein the generic ID value is associated with the client device.

For example, the receiving at block 1102 may include receiving an electrical signal indicating the generic ID from host 102.

Further, for example, the receiving at block 1102 may be performed by device 106-112 and allow one of devices 106-112 to acquire control over bus 104 for response to host 102.

At block 1104, the method 1100 includes sending a device ID on the communication bus. For example, in an aspect, device 106-112, state machine 107, (which may be embodied as an optional memory 111 and processor 113), communication component 116, and/or sending component 1025 may be configured to or may comprise means for sending a device ID on the communication bus.

For example, the sending at block 1104 may include sending an electrical signal indicating the EID of that device 106-112 to host 102.

At block 1106, the method 1100 includes receiving a unique network ID value on the communication bus. For example, in an aspect, device 106-112, state machine 107, (which may be embodied as an optional memory 111 and processor 113), communication component 116, and/or receiving component 1030 may be configured to or may comprise means for receiving a unique network ID value on the communication bus.

In an alternative or additional aspect, the network is a controller area network (CAN).

In an alternative or additional aspect, the device ID is based on an extended ID (EID), wherein the unique network ID value is based on the device ID.

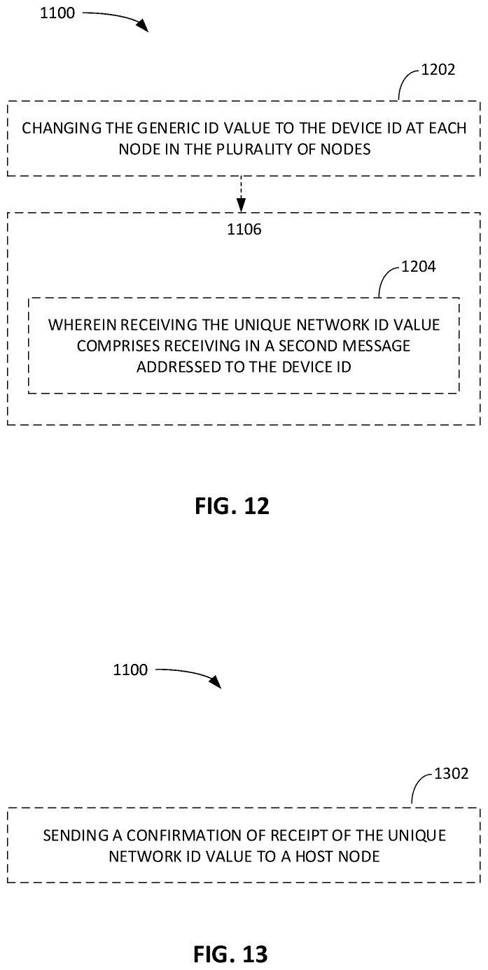

FIG. 12 is a flowchart of additional aspects of the method of FIG. 11.

Referring to FIG. 12, in an alternative or additional aspect, at block 1202, the method 1100 may further include changing the generic ID value to the device ID at each node in the plurality of nodes. For example, in an aspect, device 106-112, state machine 107, (which may be embodied as an optional memory 111 and processor 113), communication component 116, and/or changing component 1035 may be configured to or may comprise means for changing the generic ID value to the device ID at each node in the plurality of nodes.

In this optional aspect, at block 1204, the receiving at block 1106 of the unique network ID value comprises receiving in a second message addressed to the device ID.

FIG. 13 is a flowchart of additional aspects of the method of FIG. 11.

Referring to FIG. 13, in an alternative or additional aspect, at block 1302, the method 1100 may further include sending a confirmation of receipt of the unique network ID value to a host node. For example, in an aspect, device 106-112, state machine 107, (which may be embodied as an optional memory 111 and processor 113), communication component 116, and/or sending component 1040 may be configured to or may comprise means for sending a confirmation of receipt of the unique network ID value to a host node.

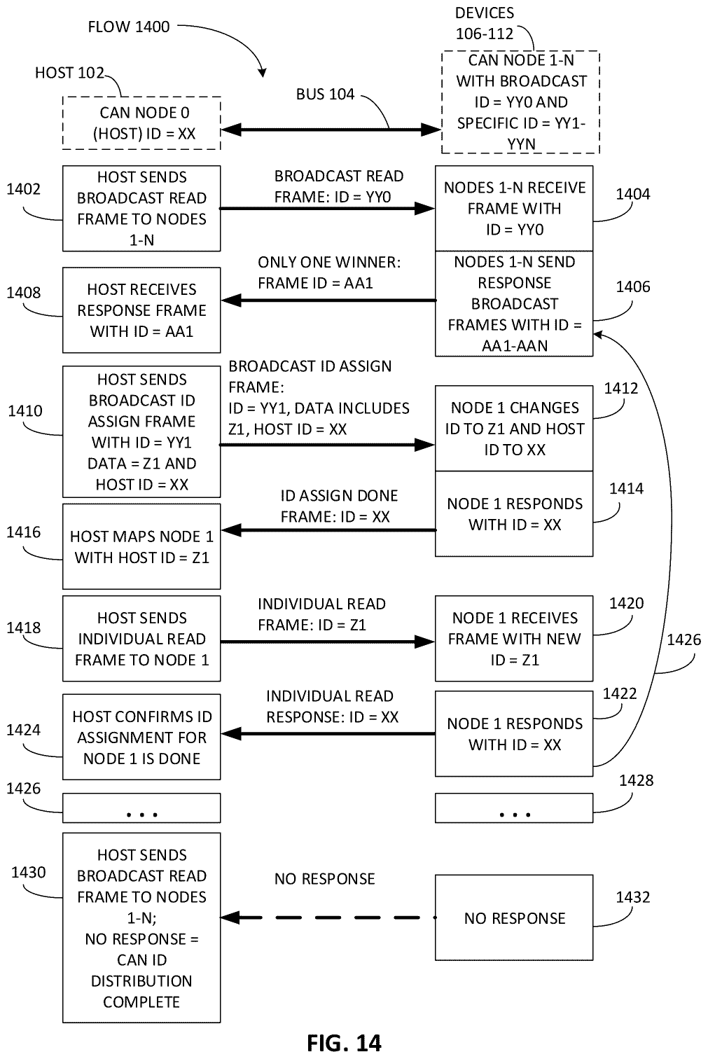

FIG. 14 illustrates a communications flow diagram in accordance with an aspect of the present disclosure.

Flow 1400 illustrates a communications flow between host 102 and devices 106-112 on bus 104. Each connection, or “node” to bus 104 has a logical number assigned to that connection. In an aspect of the present disclosure, bus 104 is a CAN bus, and host 102 is assigned to logical Node 0 on bus 104.

Host 102 may be a processor or other microcontroller that initiates and receives electrical signals (“messages”) over bus 104 to monitor the status of each of the devices 106-112 on the bus 104. However, to manage the electrical signals on bus 104, and to be able to identify a respective device, each device 106-112 on bus 104 may also be assigned a different logical number as a node on bus 104. These nodes or logical number assignments may be referred to as node 1, node 2, etc., and may be referred to as “nodes 1-n” to denote “n” number of nodes on the bus 104. These nodes are given specific identifiers in the present disclosure.

Host 102 may be assigned to CAN node 0 and has a bus ID (also referred to as a CAN ID herein) of a specific, unique value. For example, and not by way of limitation, host 102 may be assigned a bus ID of “XX”, although any device ID can be used without departing from the scope of the present disclosure.

Initially, each of devices 106-112 (also referred to as nodes 106-112 herein) may have a common or generic network ID as a default prior to bus 104 initialization. As such, the generic network ID for each device 106-112 may be referred to as “YY” or “YY1, YY2, . . . . YYn” herein. The network ID for each device 106-112 for a particular bus 104 may be assigned by host 102 as described herein.

During communication on the bus 104, an identifier, e.g., the device ID of the initiator (sender) of the recipient of the message may be referred to as the “data” of the message, and the intended recipient may be referred to as the “frame” of the message being sent.

In FIG. 3, the data field of the host 102 transmission included the ID for a given node, which was responded to with an ID or EID from a node on the CAN bus 104. In the aspect described in FIG. 14, the broadcast read frame is used by host 102 to initiate the ID distribution to devices 106-112.

In operation 1402, host 102 sends a broadcast read frame to devices 106-112 which includes an identification (ID) of YY0 to the devices 106-112 on bus 104.

Although each device 106-112 will receive the broadcast read frame in operation 1404, only one device 106-112 will be able to control the bus 104 to return a message on bus 104. In an aspect of the present disclosure, the device 106-112 that has a highest priority on bus 104 will “win” control of the bus 104, and be able to respond to the operation 1404 received by all devices 106-112.

On a bus 104 that is a CAN bus, data transmissions are distinguished by a unique message identifier, which may be 11 bits or 29 bits, which represents a number of things including the ID of the transmitting device and the message priority on bus 104. A low message ID represents a high priority. A CAN node or device may send or receive any number of messages, which contributes to a high level of flexibility.

The priority of the messages is defined by a field in the message identifier known as the arbitration field and a remote transmission request (RTR) bit. Bus 104 arbitration may be done by the host 102 and devices 106-112 by monitoring the bus 104. If a device 106-112 detects a dominant level in the arbitration field in messages not sent by that device, that device will cease transmission and become a receiver, or be in the “listen” state upon determining that another device 106-112 has higher priority.

The device 106-112 with the highest priority, e.g., device 106, will acquire control over bus 104, and the remaining devices 108-112 on bus 104 will not be allowed to access the bus 104, e.g., those devices will have their bus 104 transmission communications “disabled”. The disabled devices on bus 104 can still receive messages from host 102 or other devices 106-112 on bus 104, but the disabled devices are in “listen” mode. For case of understanding, the remainder of this example will use device 106 (also referred to as “node 1” herein) as the device with the highest priority on bus 104, although it is to be understood that any device 106-112 could have been the device with the highest priority on bus 104.

In operation 1406, device 106 (i.e., the device with the highest priority on bus 104) responds to host 102 with a broadcast frame ID equal to one of AA1 to AAn, with the respective value of 1 to n corresponding to a different response ID value for each of the nodes 1 to n, where the respective value of AA1 to AAn can correspond to a default unique ID (UID) of the respective device. In this example, the value AA1 of node 1 has the highest priority, and the other nodes switch to idle mode.

In operation 1408, host 102 receives the response frame having an ID of AA1, and in response, in operation 1410, sends a broadcast ID assign frame with an ID of one of YY1 to YYn, data including Z1, and a host ID of XX. In this case, each value of YY1 to YYn is a specific device ID corresponding one of the respective devices 106-112, where each value of YY1 to YYn corresponds to the UID of each respective device. In this example, the broadcast ID assign frame has an ID of YY1, which corresponds to device 106, e.g., node 1.

Because device 106 has control of bus 104, device 106 will act upon operation 1410 in operation 1412, where device 106 (node 1) receives the broadcast ID assign frame with ID=YY1 and data including Z1, as well as the host ID of XX. As part of operation 1412, device 106 (node 1) changes its ID to Z1 and the host ID to XX, and disables its broadcast ID.

In operation 1414, after operation 1412 is completed, device 106 (node 1) then responds on bus 104 with an ID Assign Done Frame having an ID of XX to host 102.

In operation 1416, after host 102 receives the ID Assign Done Frame message from device 106 (node 1), host 102 maps device 106 (node 1) with an ID of Z1. This mapping informs host 102 of which one of the devices 106-112 that is present at the bus 104 is to be assigned as node 1 by host 102. The mapped network ID may be stored in memory 103 for use by host 102 on bus 104.

To confirm that device 106 (node 1) is correctly assigned on bus 104, host 102 then sends, in operation 1418, an individual read frame to device 106 (node 1) with an ID=Z1. In operation 1420, device 106 (node 1) receives the individual read frame with the ID of Z1, and responds in operation 1422 on bus 104 with an individual read response having an ID of XX (the host 102 bus ID).

In operation 1424, host 102 confirms that the bus identifier for device 106 (node 1) is completed.

Once this occurs, in operation 1426, control returns to host 102, which repeats the broadcast read frame to devices 106-112 as described in operation 1402. Since device 106 (node 1) already has an assignment on bus 104, device 106 (node 1) will not respond to the broadcast read frame in operation 1402, and the device 108-112 that has the next highest priority will obtain control of the bus 104 in operation 1406. This process will continue, as shown in operation 1426 and operation 1428, until operation 1430. Operations 1426 and 1428 show a repetition of operations 1402-1424 for the additional devices 106-112 that are coupled to bus 104. Each device 106-112 will sequentially acquire the bus, send their IDs to host 102, and go through the process of having a network ID assigned by host 102.

In operation 1430, host 102 will send a broadcast read frame to devices 106-112 on bus 104, similarly to where host 102 sends the broadcast read frame in operation 1402. Once all of the devices 106-112 have identifiers assigned on bus 104, however, host 102 will not receive a response (e.g., host 102 does not receive a response as it does in operation 1406). Instead, the no response of operation 1432 will occur. Once host 102 determines a “no response” in operation 1432, or a sufficient amount of time has elapsed without receiving a response from any devices 106-112 on bus 104, host 102 will have assigned all of the identifiers on bus 104, and the distribution of identifiers will be considered completed.

As shown in FIG. 14, host 102 distributes network IDs to device 106, device 108, device 110, and device 112, and stores the distributed network IDs for bus 104 communication purposes.

In an aspect of the present disclosure, devices 106-112 place their device IDs in either the frame ID field (FIG. 14) or in the data field (FIG. 3). If the device ID is placed in the data field, then devices 106-112 may be in a passive error state. If the device ID is placed in the frame ID field, devices 106-112 may not be in a passive error state.

A passive error state may be used by devices 106-112 because an arbitration failure in the frame ID field will not destroy the current communication if the devices 106-112 are not in a passive error state. If the arbitration failure exists in the data field, such an error may not inhibit communication on bus 104 when devices 106-112 are in a passive error state.

In other words, to summarize, in the communications flow 1400, CAN Node 0 is the host, which may includes a processor, whose targeted ID will be XX (after ID distribution, the target host ID is XX, but in initial state, host can receive all the frames from CAN Nodes 1 to n). The host will take charge of the CAN Nodes ID management and distribution in the CAN network.

Further, CAN Node 1 to n are general CAN Nodes who have a same broadcast CAN ID (YY0), a specific ID from YY1 to YYn corresponding to its UID, and a different response ID from AA1 to AAn corresponding to its UID in default. The mapping strategy of YYx (x can be 1 to N) and AAx to its UID is similar, allowing the host to determine the YYx based on the received AAx.

Additionally, at the CAN network initial stage, the host will issue a broadcast read frame with ID==YY0, and Node 1 to n receive this frame and respond with different response IDs. Assuming that the frame with ID=AA1 from Node 1 has the highest transmission priority and wins the bus, all other nodes fail to transmit the frame and go to the idle state.

Then, based on the received ID (AA1), the host will determine the specific ID of Node 1 (YY1) and use the broadcast ID assign frame with ID=YY1 to assign the ID of Node 1 as the expected one (Z1) with host ID XX. Node 1 will disable the broadcast ID and then respond with the ID assign done frame with host ID XX.

After that, the domain controller (e.g., the host) can issue the individual read frame with the assigned ID Z1, and Node 1 will send an individual read response frame with host ID XX, showing that both CAN ID and host ID of Node 1 are as expected.

Following a similar procedure, the host can distribute CAN IDs as Z1 to Zn with host ID as XX to the remaining ones of CAN Node 1 to n.

Then ID distribution procedure of CAN Node 0 is finished.

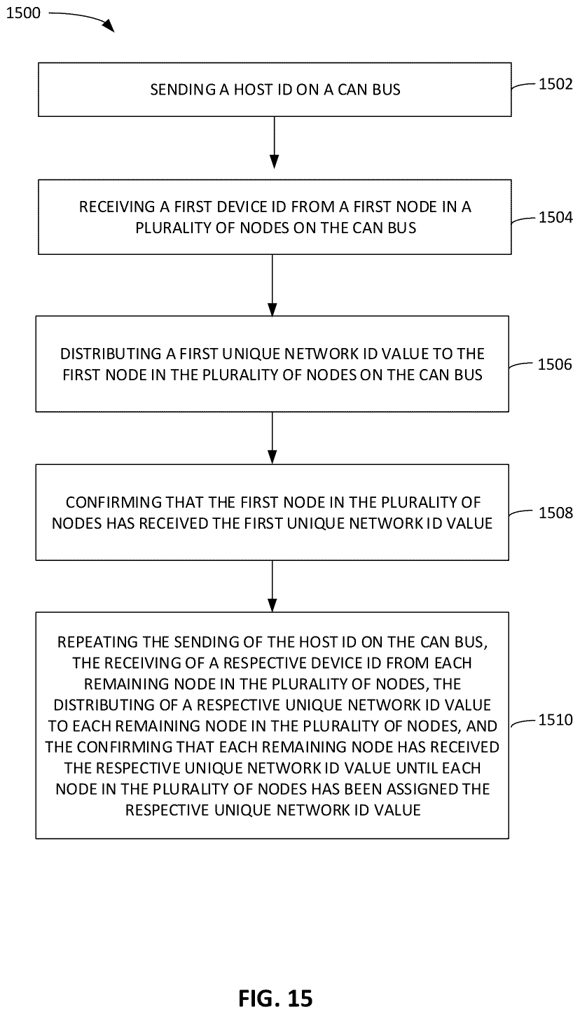

FIG. 15 is a flowchart of an example of a method 1500 of network identification (ID) distribution by a host device in a network.

For example, in operation, host 102 device in a bus architecture 100 (or other network) as described with respect to FIG. 3 and/or FIG. 14 may perform all or at least a portion of the method 1500 of controller area network (CAN) identification (ID) distribution by host 102, processor 105, or memory 103. Also, in this example, devices 106-112 on bus 104 may respond to the host device 102.

At block 1502, the method 1500 includes sending a host ID on a CAN bus. For example, in an aspect, host 102, memory 103, processor 105, communication component 115, and/or sending component 420 may be configured to or may comprise means for sending the host ID on the CAN bus. For example, the sending at block 1502 may include sending electrical signals from host 102 to devices 106-112 on bus 104 to begin assignment of network IDs. Further, for example, the sending at block 1502 may be performed by host 102 to inform devices 106-112 of the host 102 network ID.

At block 1504, the method 1500 includes receiving a first device ID from a first node in a plurality of nodes on the CAN bus. For example, in an aspect, host 102, memory 103, processor 105, communication component 115, and/or receiving component 425 may be configured to or may comprise means for receiving a first device ID from a first node in a plurality of nodes on the CAN bus. For example, the receiving at block 1504 may include receiving electrical signals from one of devices 106-112 on bus 104 at host 102. Further, for example, the receiving at block 1504 may be performed to let host 102 know that one of devices 106-112 is able to communicate on bus 104.

At block 1506, the method 1500 includes distributing a first unique network ID value to the first node in the plurality of nodes on the CAN bus. For example, in an aspect, host 102, memory 103, processor 105, communication component 115, and/or distributing component 430 may be configured to or may comprise means for distributing a first unique network ID value to the first node in the plurality of nodes on the CAN bus. For example, the distributing at block 1506 may include determining a unique network ID at host 102 and assigning this to the responding node on bus 104. Further, for example, the distributing at block 1506 may be performed to begin communication with one of devices 106-112.

At block 1508, the method 1500 includes confirming that the first node in the plurality of nodes has received the first unique network ID value. For example, in an aspect, host 102, memory 103, processor 105, communication component 115, and/or repeating component 435 may be configured to or may comprise means for confirming that the first node in the plurality of nodes has received the first unique network ID value. For example, the confirming at block 1508 may include sending individual read frames to each of devices 106-112 on bus 104.

At block 1510, the method 1500 includes repeating the sending of the host ID on the CAN bus, the receiving of a respective device ID from each remaining node in the plurality of nodes, the distributing of a respective unique network ID value to each remaining node in the plurality of nodes, and the confirming that each remaining node has received the respective unique network ID value until each node in the plurality of nodes has been assigned the respective unique network ID value. For example, in an aspect, host 102, memory 103, processor 105, communication component 115, and/or repeating component 435 may be configured to or may comprise means for repeating the sending of the host ID on the CAN bus, the receiving of a respective device ID from each remaining node in the plurality of nodes, the distributing of a respective unique network ID value to each remaining node in the plurality of nodes, and the confirming that each remaining node has received the respective unique network ID value until each node in the plurality of nodes has been assigned the respective unique network ID value. For example, the repeating at block 1508 may include assigning unique network IDs to each of devices 106-112 on bus 104.

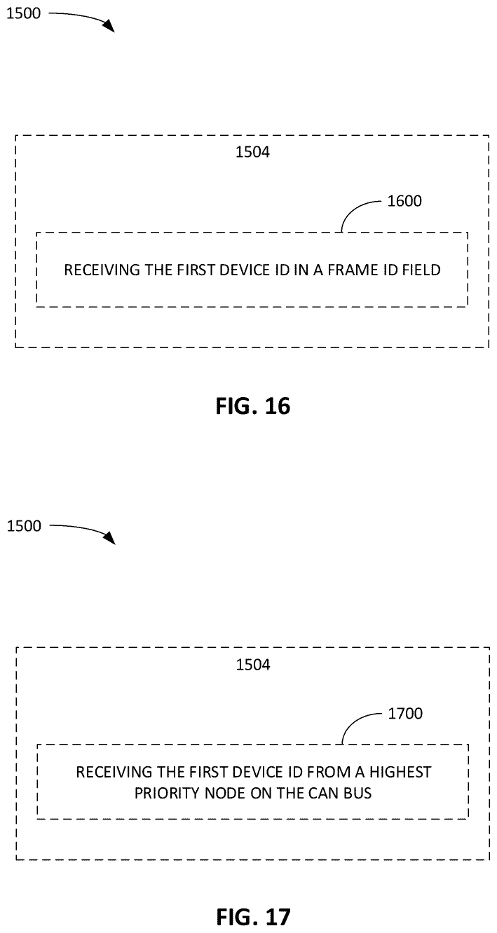

FIG. 16 is a flowchart of additional aspects of the method of FIG. 15.

Referring to FIG. 16, in an alternative or additional aspect, at block 1600, the receiving at block 1504 of the first device ID comprises receiving the first device ID in a frame ID field.

FIG. 17 is a flowchart of additional aspects of the method of FIG. 15.

Referring to FIG. 17, in an alternative or additional aspect, at block 1700, the receiving at block 1504 of the first device ID comprises receiving the first device ID from a highest priority node on the CAN bus.

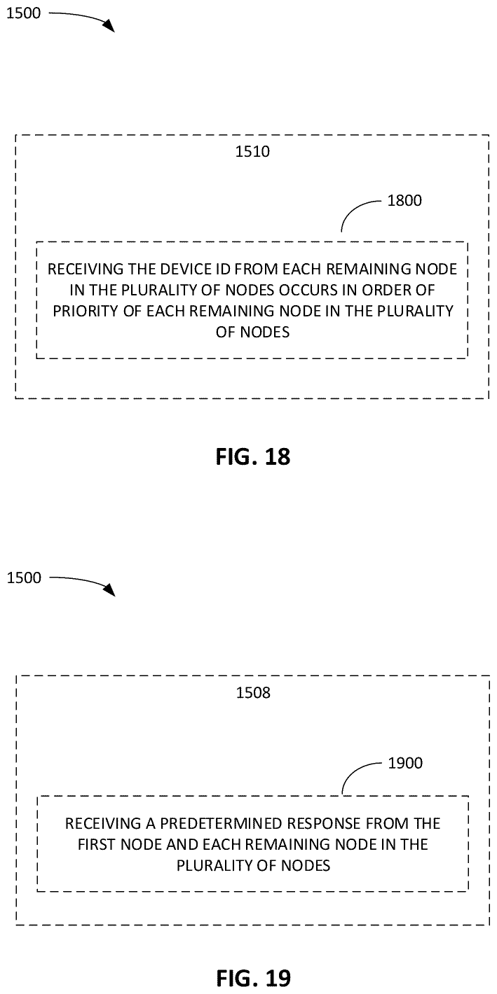

FIG. 18 is a flowchart of additional aspects of the method of FIG. 15.

Referring to FIG. 18, in an alternative or additional aspect, at block 1800, the receiving at block 1510 of the device ID from each remaining node in the plurality of nodes occurs in order of priority of each remaining node in the plurality of nodes.

FIG. 19 is a flowchart of additional aspects of the method of FIG. 15.

Referring to FIG. 19, in an alternative or additional aspect, at block 1900, the confirming at block 1508 that the first node in the plurality of nodes has received the first unique network ID value and confirming that each remaining node in the plurality of nodes has received the respective unique device ID value further comprises receiving a predetermined response from the first node and each remaining node in the plurality of nodes.

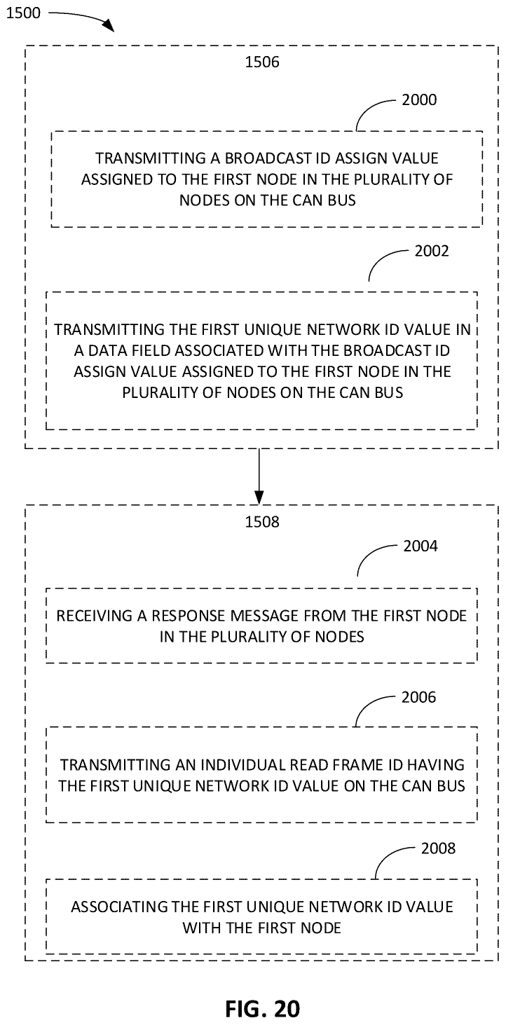

FIG. 20 is a flowchart of additional aspects of the method of FIG. 15.

Referring to FIG. 20, in an alternative or additional aspect, the distributing, in block 1506, of the first unique network ID value to the first node in the plurality of nodes on the CAN bus further comprises, at block 2000, transmitting a broadcast ID assign value assigned to the first node in the plurality of nodes on the CAN bus, and at block 2002, transmitting the first unique network ID value in a data field associated with the broadcast ID assign value assigned to the first node in the plurality of nodes on the CAN bus

Further referring to FIG. 20, in an alternative or additional aspect, the confirming at block 1508 that the first node in the plurality of nodes has received the first unique network ID value further comprises, at block 2004, receiving a response message from the first node in the plurality of nodes, at block 2006, transmitting an individual read frame ID having the first unique network ID value on the CAN bus, and at block 2008, associating the first unique network ID value with the first node.

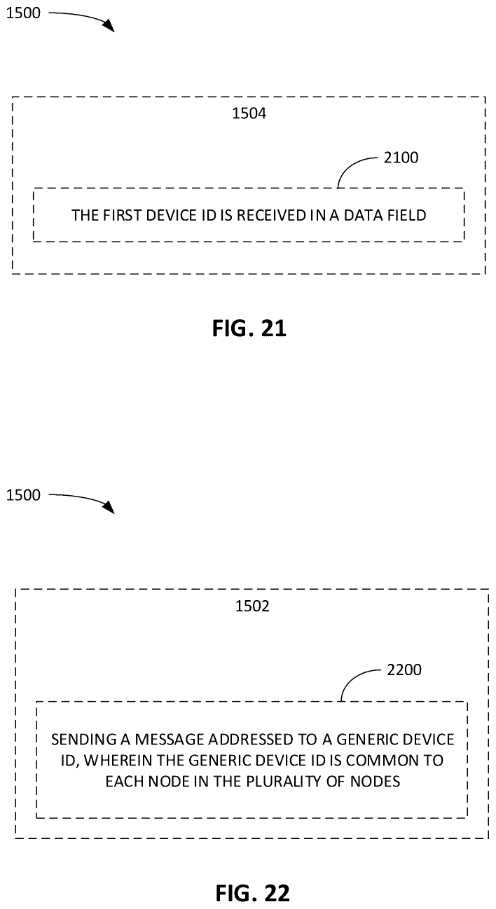

FIG. 21 is a flowchart of additional aspects of the method of FIG. 15.

Referring to FIG. 21, in an alternative or additional aspect, the receiving at block 1504 of the first device ID comprises, in block 2100, receiving the first device ID in a data field.

FIG. 22 is a flowchart of additional aspects of the method of FIG. 15.

Referring to FIG. 22, in an alternative or additional aspect, the sending, in block 1502, of the host ID comprises, in block 2200, sending a message addressed to a generic device ID, wherein the generic device ID is common to each node in the plurality of nodes.

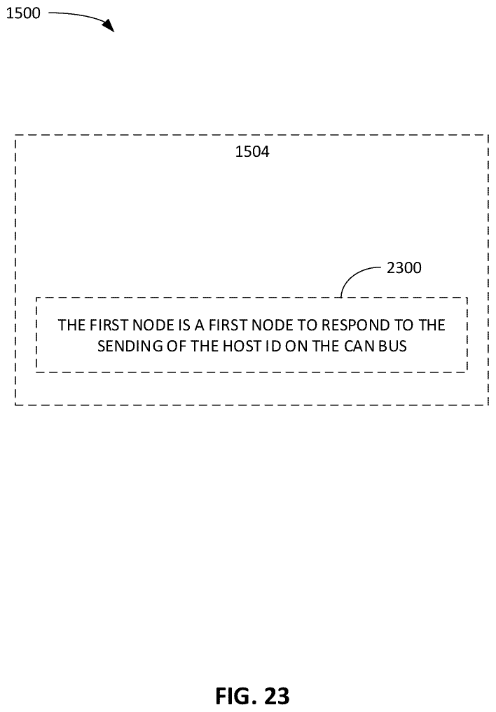

FIG. 23 is a flowchart of additional aspects of the method of FIG. 15.

Referring to FIG. 23, in an alternative or additional aspect, the receiving at block 1504 of the first device ID comprises, at block 2300, the first node is a first node to respond to the sending of the host ID on the CAN bus.

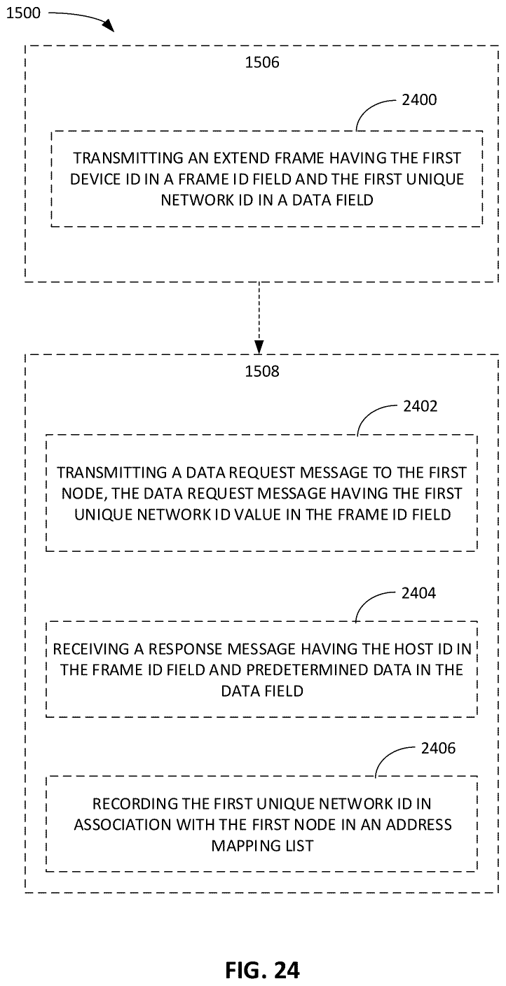

FIG. 24 is a flowchart of additional aspects of the method of FIG. 15.

Referring to FIG. 24, in an alternative or additional aspect, the distributing, in block 1506, of the first unique network ID value to the first node in the plurality of nodes on the CAN bus further comprises, at block 2400, transmitting an extend frame having the first device ID in a frame ID field and the first unique network ID in a data field. The confirming at block 1508 that the first node in the plurality of nodes has received the first unique network ID value further comprises, at block 2402, transmitting a data request message to the first node, the data request message having the first unique network ID value in the frame ID field, at block 2404, receiving a response message having the host ID in the frame ID field and predetermined data in the data field, and at block 2406, recording the first unique network ID in association with the first node in an address mapping list.

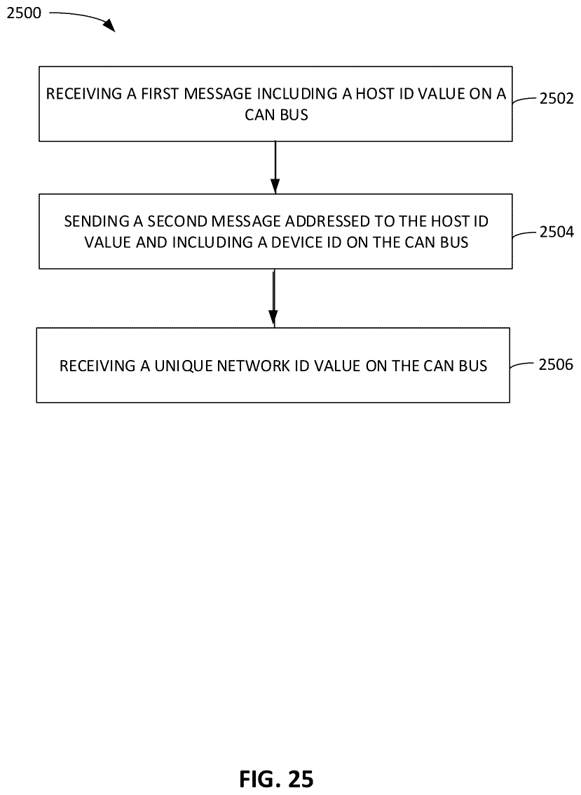

FIG. 25 is a flowchart of an example of a method 2500 of network identification (ID) distribution by a node in a plurality of nodes in a network.

For example, in operation, device 106-112, such as a device in a network as described in FIG. 3 and/or FIG. 14, may perform all or at least a portion of the method 2500 of obtaining a controller area network (CAN) identification (ID) by a node of a plurality of nodes in a network, such as via execution by devices 106-112.

At block 2502, the method 2500 includes, at block 2502, receiving a first message including a host ID value on a CAN bus. For example, in an aspect, device 106-112, state machine 107, (which may be embodied as an optional memory 111 and processor 113), communication component 116, and/or receiving component 1020 may be configured to or may comprise means for receiving a first message including a host ID value on a CAN bus. For example, the receiving at block 2502 may include receiving an electrical signal from host 102. Further, for example, the receiving at block 1102 may be performed by device 106-112 and allow one of devices 106-112 to acquire control over bus 104 for response to host 102.

At block 2504, the method 2500 includes sending a second message addressed to the host ID value and including a device ID on the CAN bus. For example, in an aspect, device 106-112, state machine 107, (which may be embodied as an optional memory 111 and processor 113), communication component 116, and/or sending component 1025 may be configured to or may comprise means for sending a second message addressed to the host ID value and including a device ID on the CAN bus. For example, the sending at block 2504 may include sending an electrical signal indicating the ID of that device 106-112 to host 102.

At block 2506, the method 2500 includes receiving a unique network ID value on the CAN bus. For example, in an aspect, device 106-112, state machine 107, (which may be embodied as an optional memory 111 and processor 113), communication component 116, and/or sending component 1025 may be configured to or may comprise means for receiving a unique network ID value on the CAN bus.

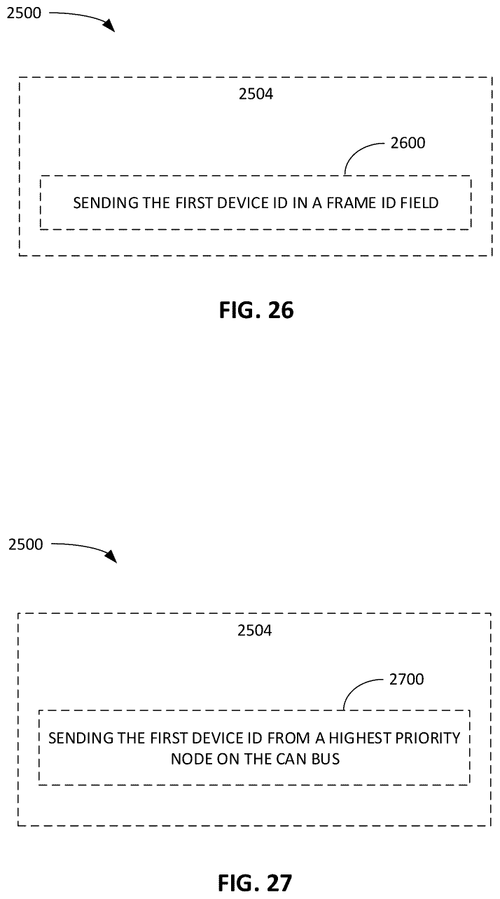

FIG. 26 is a flowchart of additional aspects of the method of FIG. 25.

Referring to FIG. 26, in an alternative or additional aspect, at block 2600, the sending at block 2504 of the first device ID comprises sending the first device ID in a frame ID field.

FIG. 27 is a flowchart of additional aspects of the method of FIG. 25.

Referring to FIG. 27, in an alternative or additional aspect, at block 2700, the sending at block 2504 of the first device ID comprises sending the first device ID from a highest priority node on the CAN bus.

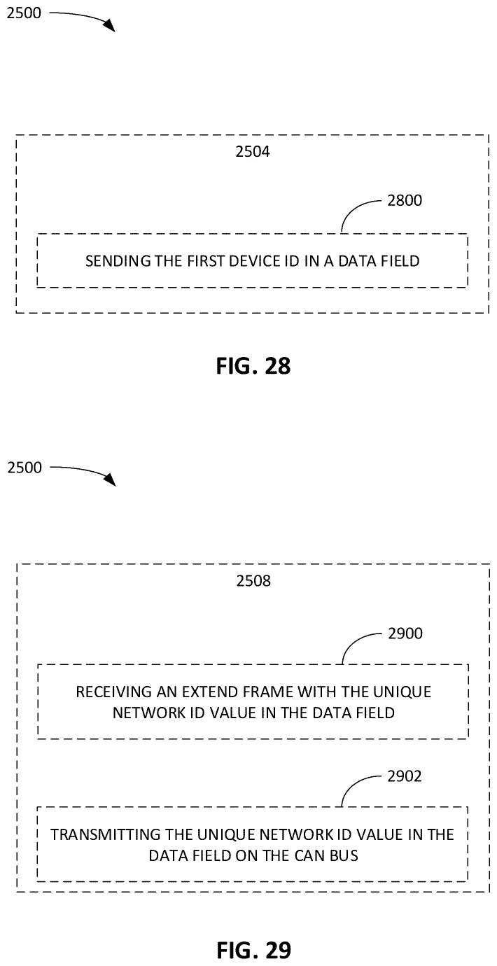

FIG. 28 is a flowchart of additional aspects of the method of FIG. 25.

Referring to FIG. 28, in an alternative or additional aspect, at block 2800, the sending at block 2504 of the first device ID comprises sending the first device ID in a data field.

FIG. 29 is a flowchart of additional aspects of the method of FIG. 25.

Referring to FIG. 29, in an alternative or additional aspect, the receiving a unique network ID value on the CAN bus in block 2508 further comprises, in block 2900, receiving an extend frame with the unique network ID value in the data field, and in block 2902, transmitting the unique network ID value in the data field on the CAN bus.

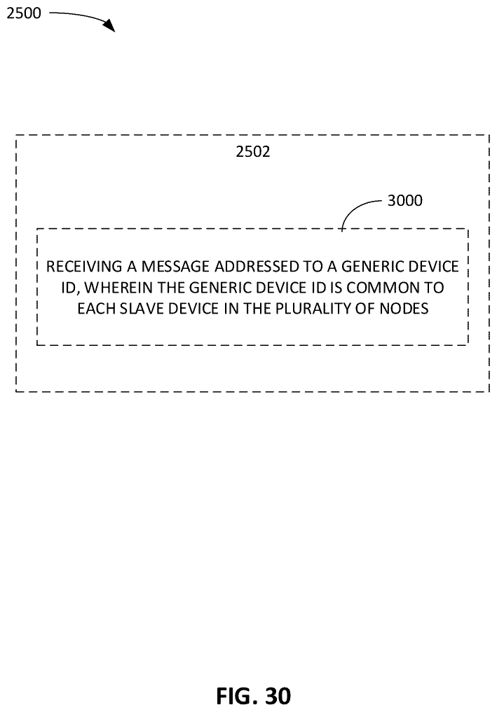

FIG. 30 is a flowchart of additional aspects of the method of FIG. 25.

Referring to FIG. 30, in an alternative or additional aspect, the receiving a first message including a host ID value on a CAN bus in block 2502 further comprises, in block 3000, receiving a message addressed to a generic device ID, wherein the generic device ID is common to each client device in the plurality of nodes.

In summary, the present disclosure may be embodied in one or more of the following clauses.

Clause 1. A method of controller area network (CAN) identification (ID) distribution by a host device in a network, comprising: sending a host ID on a CAN bus; receiving a first device ID from a first node in a plurality of nodes on the CAN bus; distributing a first unique network ID value to the first node in the plurality of nodes on the CAN bus; confirming that the first node in the plurality of nodes has received the first unique network ID value; and repeating sending of the host ID on the CAN bus, receiving of a respective device ID from each remaining node in the plurality of nodes, distributing of a respective unique network ID value to each remaining node in the plurality of nodes, and confirming that each remaining node has received the respective unique network ID value until each node in the plurality of nodes has been assigned the respective unique network ID value.

Clause 2. The method of clause 1, wherein the first device ID is received in a frame ID field.

Clause 3. The method of clause 1, wherein the first node is a highest priority node on the CAN bus.

Clause 4. The method of clause 3, wherein receiving the respective device ID from each remaining node in the plurality of nodes occurs in order of priority of each remaining node in the plurality of nodes.

Clause 5. The method of clause 1, wherein confirming that the first node in the plurality of nodes has received the first unique network ID value and confirming that each remaining node in the plurality of nodes has received the respective unique network ID value further comprises receiving a predetermined response from the first node and each remaining node in the plurality of nodes.

Clause 6. The method of clause 1, wherein distributing the first unique network ID value to the first node in the plurality of nodes on the CAN bus further comprises: transmitting a broadcast ID assign value assigned to the first node in the plurality of nodes on the CAN bus; and transmitting the first unique network ID value in a data field associated with the broadcast ID assign value assigned to the first node in the plurality of nodes on the CAN bus; and wherein confirming that the first node in the plurality of nodes has received the first unique network ID value further comprises: receiving a response message from the first node in the plurality of nodes; transmitting an individual read frame ID having the first unique network ID value on the CAN bus; and associating the first unique network ID value with the first node.

Clause 7. The method of clause 1, wherein the first device ID is received in a data field.

Clause 8. The method of clause 7, wherein sending the host ID comprises sending a message addressed to a generic device ID, wherein the generic device ID is common to each node in the plurality of nodes.

Clause 9. The method of clause 7, wherein the first node is a first node to respond to the sending of the host ID on the CAN bus.

Clause 10. The method of clause 7, wherein distributing a first unique network ID value to the first node in the plurality of nodes on the CAN bus further comprises: transmitting an extend frame having the first device ID in a frame ID field and the first unique network ID value in a data field; wherein confirming that the first node in the plurality of nodes has received the first unique network ID value further comprises: transmitting a data request message to the first node, the data request message having the first unique network ID value in the frame ID field; receiving a response message having the host ID in the frame ID field and predetermined data in the data field; and recording the first unique network ID value in association with the first node in an address mapping list.

Clause 11. An apparatus for controller area network (CAN) identification (ID) distribution by a host device in a network, comprising: a memory; and a processor communicatively coupled with the memory and configured to: send a host ID on a CAN bus; receive a first device ID from a first node in a plurality of nodes on the CAN bus; distribute a first unique network ID value to the first node in the plurality of nodes on the CAN bus; confirm that the first node in the plurality of nodes has received the first unique network ID value; and repeat sending of the host ID on the CAN bus, receiving of a respective device ID from each remaining node in the plurality of nodes, distributing of a respective unique network ID value to each remaining node in the plurality of nodes, and confirming that each remaining node has received the respective unique network ID value until each node in the plurality of nodes has been assigned the respective unique network ID value.

Clause 12. The apparatus of clause 11, wherein the processor is further configured to receive the first device ID in a frame ID field.

Clause 13. The apparatus of clause 11, wherein the first node is a highest priority node on the CAN bus.

Clause 14. The apparatus of clause 13, wherein the respective device ID received from each remaining node in the plurality of nodes occurs in order of priority of each remaining node in the plurality of nodes.

Clause 15. The apparatus of clause 11, wherein when confirming that the first node in the plurality of nodes has received the first unique network ID value and confirming that each remaining node in the plurality of nodes has received the respective unique network ID value the processor is further configured to receive a predetermined response from the first node and each remaining node in the plurality of nodes.

Clause 16. The apparatus of clause 11, wherein when the first unique network ID value is distributed to the first node in the plurality of nodes on the CAN bus, the processor is further configured to: transmit a broadcast ID assign value assigned to the first node in the plurality of nodes on the CAN bus; and transmit the first unique network ID value in a data field associated with the broadcast ID assign value assigned to the first node in the plurality of nodes on the CAN bus; and wherein when confirming that the first node in the plurality of nodes has received the first unique network ID value, the processor is further configured to: receive a response message from the first node in the plurality of nodes; transmit an individual read frame ID having the first unique network ID value on the CAN bus; and associate the first unique network ID value with the first node.

Clause 17. The apparatus of clause 11, wherein the processor is further configured to receive the first device ID in a data field.

Clause 18. The apparatus of clause 17, wherein when sending the host ID the processor is further configured to send a message addressed to a generic device ID, wherein the generic device ID is common to each node in the plurality of nodes.

Clause 19. The apparatus of clause 17, wherein the first node is a first node to respond to the sending of the host ID on the CAN bus.

Clause 20. The apparatus of clause 17, wherein when distributing a first unique network ID value to the first node in the plurality of nodes on the CAN bus, the processor is further configured to: transmit an extend frame having the first device ID in a frame ID field and the first unique network ID value in a data field; wherein when confirming that the first node in the plurality of nodes has received the first unique network ID value the processor is further configured to: transmit a data request message to the first node, the data request message having the first unique network ID value in the frame ID field; receive a response message having the host ID in the frame ID field and predetermined data in the data field; and record the first unique network ID value in association with the first node in an address mapping list.

Clause 21. A method of obtaining a controller area network (CAN) identification (ID) by a node of a plurality of nodes in a network, comprising: receiving a first message including a host ID value on a CAN bus; sending a second message addressed to the host ID value and including a device ID on the CAN bus; and receiving a unique network ID value on the CAN bus.

Clause 22. The method of clause 21, wherein the device ID is sent in a frame ID field.

Clause 23. The method of clause 21, wherein the node is a highest priority node on the CAN bus.

Clause 24. The method of clause 21, wherein the device ID is sent in a data field.

Clause 25. The method of clause 24, further comprising: receiving an extend frame with the unique network ID value in the data field; and transmitting the unique network ID value in the data field on the CAN bus.

Clause 26. The method of clause 24, wherein receiving the host ID value comprises receiving a message addressed to a generic device ID, wherein the generic device ID is common to each node in the plurality of nodes.

Clause 27. An apparatus for controller area network (CAN) identification (ID) distribution to a plurality of nodes in a network, comprising: a state machine configured to: receive a first message including a host ID value on a CAN bus; send a device ID on the CAN bus from a first node in the plurality of nodes; and receive a unique network ID value on the CAN bus.

Clause 28. The apparatus of clause 27, wherein the state machine is further configured to send the device ID in a frame ID field.

Clause 29. The apparatus of clause 27, wherein the first node is a highest priority node on the CAN bus.

Clause 30. The apparatus of clause 27, wherein the state machine is further configured to receive the device ID in a data field.

Clause 31. The apparatus of clause 30, the state machine being further configured to: receive an extend frame with the unique network ID value in the data field; and transmit the unique network ID value in the data field on the CAN bus.

Clause 32. The apparatus of clause 30, the state machine being further configured to: receive a message addressed to a generic device ID, wherein the generic device ID is common to each node in the plurality of nodes.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of controller area network (CAN) identification (ID) distribution by a host device in a network, comprising:
sending a host ID on a CAN bus;
receiving a first device ID from a first node in a plurality of nodes on the CAN bus;
distributing a first unique network ID value to the first node in the plurality of nodes on the CAN bus;
confirming that the first node in the plurality of nodes has received the first unique network ID value; and
repeating sending of the host ID on the CAN bus, receiving of a respective device ID from each remaining node in the plurality of nodes, distributing of a respective unique network ID value to each remaining node in the plurality of nodes, and confirming that each remaining node has received the respective unique network ID value until each node in the plurality of nodes has been assigned the respective unique network ID value.

2. The method of claim 1, wherein the first device ID is received in a frame ID field.

3. The method of claim 1, wherein the first node is a highest priority node on the CAN bus.

4. The method of claim 3, wherein receiving the respective device ID from each remaining node in the plurality of nodes occurs in order of priority of each remaining node in the plurality of nodes.

5. The method of claim 1, wherein confirming that the first node in the plurality of nodes has received the first unique network ID value and confirming that each remaining node in the plurality of nodes has received the respective unique network ID value further comprises receiving a predetermined response from the first node and each remaining node in the plurality of nodes.

6. The method of claim 1, wherein distributing the first unique network ID value to the first node in the plurality of nodes on the CAN bus further comprises:
transmitting a broadcast ID assign value assigned to the first node in the plurality of nodes on the CAN bus; and
transmitting the first unique network ID value in a data field associated with the broadcast ID assign value assigned to the first node in the plurality of nodes on the CAN bus;
and wherein confirming that the first node in the plurality of nodes has received the first unique network ID value further comprises:
receiving a response message from the first node in the plurality of nodes;
transmitting an individual read frame ID having the first unique network ID value on the CAN bus; and
associating the first unique network ID value with the first node.

7. The method of claim 1, wherein the first device ID is received in a data field.

8. The method of claim 7, wherein sending the host ID comprises sending a message addressed to a generic device ID, wherein the generic device ID is common to each node in the plurality of nodes, or the first node is a first node to respond to the sending of the host ID on the CAN bus.

9. The method of claim 7, wherein distributing a first unique network ID value to the first node in the plurality of nodes on the CAN bus further comprises:
transmitting an extend frame having the first device ID in a frame ID field and the first unique network ID value in a data field;
wherein confirming that the first node in the plurality of nodes has received the first unique network ID value further comprises:
transmitting a data request message to the first node, the data request message having the first unique network ID value in the frame ID field;
receiving a response message having the host ID in the frame ID field and predetermined data in the data field; and
recording the first unique network ID value in association with the first node in an address mapping list.

10. An apparatus for controller area network (CAN) identification (ID) distribution by a host device in a network, comprising:
a memory; and
a processor communicatively coupled with the memory and configured to:
send a host ID on a CAN bus;
receive a first device ID from a first node in a plurality of nodes on the CAN bus;
distribute a first unique network ID value to the first node in the plurality of nodes on the CAN bus;
confirm that the first node in the plurality of nodes has received the first unique network ID value; and
repeat sending of the host ID on the CAN bus, receiving of a respective device ID from each remaining node in the plurality of nodes, distributing of a respective unique network ID value to each remaining node in the plurality of nodes, and confirming that each remaining node has received the respective unique network ID value until each node in the plurality of nodes has been assigned the respective unique network ID value.

11. The apparatus of claim 10, wherein the processor is further configured to receive the first device ID in a frame ID field.

12. The apparatus of claim 10, wherein the first node is a highest priority node on the CAN bus.

13. The apparatus of claim 12, wherein the respective device ID received from each remaining node in the plurality of nodes occurs in order of priority of each remaining node in the plurality of nodes.

14. The apparatus of claim 10, wherein when confirming that the first node in the plurality of nodes has received the first unique network ID value and confirming that each remaining node in the plurality of nodes has received the respective unique network ID value the processor is further configured to receive a predetermined response from the first node and each remaining node in the plurality of nodes.

15. The apparatus of claim 10, wherein when the first unique network ID value is distributed to the first node in the plurality of nodes on the CAN bus, the processor is further configured to:
transmit a broadcast ID assign value assigned to the first node in the plurality of nodes on the CAN bus; and
transmit the first unique network ID value in a data field associated with the broadcast ID assign value assigned to the first node in the plurality of nodes on the CAN bus;
and wherein when confirming that the first node in the plurality of nodes has received the first unique network ID value, the processor is further configured to:
receive a response message from the first node in the plurality of nodes;
transmit an individual read frame ID having the first unique network ID value on the CAN bus; and
associate the first unique network ID value with the first node.

16. The apparatus of claim 10, wherein the processor is further configured to receive the first device ID in a data field.

17. The apparatus of claim 16, wherein when sending the host ID the processor is further configured to send a message addressed to a generic device ID, wherein the generic device ID is common to each node in the plurality of nodes.

18. The apparatus of claim 16, wherein the first node is a first node to respond to the sending of the host ID on the CAN bus.

19. The apparatus of claim 16, wherein when distributing a first unique network ID value to the first node in the plurality of nodes on the CAN bus, the processor is further configured to:
transmit an extend frame having the first device ID in a frame ID field and the first unique network ID value in a data field;
wherein when confirming that the first node in the plurality of nodes has received the first unique network ID value the processor is further configured to:
transmit a data request message to the first node, the data request message having the first unique network ID value in the frame ID field;
receive a response message having the host ID in the frame ID field and predetermined data in the data field; and
record the first unique network ID value in association with the first node in an address mapping list.

20. A method of obtaining a controller area network (CAN) identification (ID) by a node of a plurality of nodes in a network, comprising:
receiving a first message including a host ID value on a CAN bus;
sending a second message addressed to the host ID value and including a device ID on the CAN bus; and
receiving a unique network ID value on the CAN bus.
